(19) United States
(12) Patent Application Publication
(10) Pub. No.: US 2001/0056198 A1
(43) Pub. Date: Dec. 27, 2001

(54) Process for production of bis (alkyl cyclopentadienyl) ruthenium and bis (alkyl cyclopentadienyl) ruthenium produced by the process

(75) Inventor: Katsutsugu Kitada, Kanagawa (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Tanaka Kikinzoku Kogyo K.K.

(21) Appl. No.: 09/824,250

(22) Filed: Apr. 3, 2001

(30) Foreign Application Priority Data
May 16, 2000 (JP) 2000-142746

(51) Int. Cl. C07F 17/02

(52) U.S. Cl. 556/136

(57) ABSTRACT

The present invention provides a process for producing bis(alkyl cyclopentadienyl ruthenium comprising reacting alkyl cyclopentadiene with ruthenium chloride and zinc powder in an alcohol solvent, the reaction being effected at a temperature within from −30° C. to −80° C. In the process, the alkyl cyclopentadiene may be first mixed with zinc powder in the alcohol solvent and subsequently the ruthenium chloride may be added thereto to produce bis(alkyl cyclopentadienyl) ruthenium with higher purity.

### BACKGROUND OF THE INVENTION

1. Field of the Invention

The present invention relates to a process for producing bis(alkyl cyclopentadienyl) ruthenium which is one of the organometallic compounds usable for the formation of a ruthenium thin film or a ruthenium oxide thin film by the chemical vapor deposition method.

2. Description of the Related Art

In recent years, a thin film made of a precious metal (e.g., ruthenium, platinum and iridium) or an oxide of the precious metal has been used as a material for an electrode for use in an electrical or electronic device such as a condenser for IC or LSI. This is because, when made into a thin film electrode, these precious metals exhibit good properties suitable for the electrode. In particular, ruthenium and ruthenium oxide have been focused attention, since they are expected to become the most demanded material for a thin film electrode in the future.

For producing a thin film of ruthenium or ruthenium oxide, the chemical vapor deposition method (hereinafter, simply referred to as the “CVD” method) has been commonly employed. This is because the CVD method enables the ready formation of a uniform film and is excellent in step coverage. Because of having these characteristics, the CVD method is expected to be the dominant process for producing a thin film electrode in the future, which can adapt to the recent higher density requirement for circuits and electronic components or devices.

The source materials for CVD are metallic compounds, particularly organometallic compounds which have lower melting points and are more easy to handle than other metallic compounds. For producing thin films more efficiently, studies on ruthenium-containing compounds having low melting points have been made extensively. One of the approaches for lowering a ruthenium-containing organometallic compound is to introduce an alkyl group (e.g., a methyl group and an ethyl group) to each of the both cyclopentadiene rings of bis(cyclopentadienyl) ruthenium to thereby produce bis(alkyl cyclopentadienyl) ruthenium represented by Formula (1):

Formula (1):

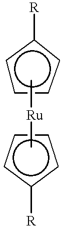

wherein a substituent R is a straight-chain or branched alkyl group.

The bis(alkyl cyclopentadienyl) ruthenium has a lower melting point than its base compound bis(cyclopentadienyl) ruthenium and a high vapor pressure, and therefore is suitable as a source material for CVD. Accordingly, this compound is considered to be a promising raw material taking the place of bis(cyclopentadienyl) ruthenium for producing a ruthenium thin film.

For producing the bis(alkyl cyclopentadienyl) ruthenium, a process is known which comprises reacting alkyl cyclopentadiene represented by Formula (5) with ruthenium chloride of Formula (6) and zinc powder. For example, the method for producing bis(alkyl cyclopentadienyl) ruthenium disclosed in Japanese Patent Application Publication Laid-open No. Hei 11-35589 employs this process, in which bis(ethyl cyclopentadienyl) ruthenium and bis(isopropyl cyclopentadienyl) ruthenium are produced exemplaryily. In this method, ruthenium chloride is first dissolved in an alcohol solvent, ethyl cyclopentadiene (or isopropyl cyclopentadiene) is then mixed to the solution, and finally zinc powder with high purity is added in portions to the mixed solution. In this patent publication, it is described that the reaction is preferably effected at a temperature within the range from −30° C. to 0° C.

Formula (2):

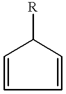

wherein a substituent R is a straight-chain or branched alkyl group.

Formula (3):

RuCl₃

However, the bis(alkyl cyclopentadienyl) ruthenium produced by the prior art process as mentioned above may contain, although a vary small amount, a derivatives(s) of bis(cyclopentadienyl) ruthenium which is closely analogous to the bis(alkyl cyclopentadienyl) ruthenium, such as a monoalkyl ruthenocene (e.g., ethyl ruthenocene) and a trialkyl ruthenocene (e.g., triethyl ruthenocene) as an impurity or impurities. Each of these impurities is produced by a side reaction which occurs simultaneously with the reaction for producing the bis(alkyl cyclopentadienyl) ruthenium.

The content of the impurity or impurities in the bis(alkyl cyclopentadienyl) ruthenium produced by the prior art process is only the order of several %. However, if such an impurity-containing bis(alkyl cyclopentadienyl) ruthenium is used as a source material for CVD, then the morphology of the film formed may be degraded and the step coverage may be adversely affected. This seems to raise a problem in producing thin film electrodes for electric and electronic devices for which exceedingly severe management of processing accuracy is required.

On the other hand, with respect to bis(alkyl cyclopentadienyl) ruthenium with low purity, there is an idea that one can only remove the impurity or impurities from the compound. However, the analogous derivatives of the bis(alkyl cyclopentadienyl) ruthenium have physical properties closely similar to that of the bis(alkyl cyclopentadienyl) ruthenium, and therefore it is quite difficult to purify the bis(alkyl cyclopentadienyl) ruthenium by conventional separation methods such as distillation and re-crystallization. Therefore, in order to ensure the production of bis(alkyl cyclopentadienyl) ruthenium with high purity useful as a source material for CVD, it is required to effect the high purification of the compound during the production process thereof.

Under these situations, the present invention has been made. Accordingly, the object of the present invention is to provide a process for producing bis(alkyl cyclopentadienyl) ruthenium with high purity containing no impurity, without occurrence of any side reaction which may produce an analogous derivative thereof as an impurity.

### SUMMARY OF THE INVENTION

In order to solve the problems as mentioned above, the present inventors made extensive studies. For preventing the occurrence of a side reaction during the production process for bis(alkyl cyclopentadienyl) ruthenium, studies have been made in terms of both reaction temperature and ratio among starting materials (i.e., an alcohol, alkyl cyclopentadiene, zinc powder and ruthenium chloride) present during the reaction. As a result, the invention has been accomplished.

The process for producing bis(alkyl cyclopentadienyl) ruthenium according to one aspect of the present invention is characterized by comprising reacting alkyl cyclopentadiene represented by Formula (4) with ruthenium chloride of Formula (5) and zinc powder in an alcohol solvent to thereby produce bis(alkyl cyclopentadienyl) ruthenium represented by Formula (6), wherein the reaction is effected at a temperature not higher than −30° C.:

Formula (4):

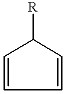

wherein a substituent R represents a strait-chain or branched alkyl group;

Formula (5):

RuCl₃; and

Formula (6):

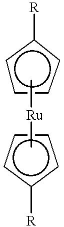

wherein a substituent R is as defined above.

The one aspect of the present invention has been made based on the study in terms of reaction temperature. In the prior art process for producing bis(alkyl cyclopentadienyl) ruthenium, the reaction temperature preferably falls within the range from 0° C. to −30° C. for the purpose of preventing the occurrence of an adverse side reaction. However, according to the present inventors, a side reaction may still occurs even at such a low reaction temperature, although a small extent. Therefore, in the present invention, for preventing the occurrence of a side reaction completely, the reaction temperature is further sifted to a lower temperature range of −30° C. to −80° C. A reaction temperature lower than −80° C. is not preferable, because the reaction for producing bis(alkyl cyclopentadienyl) ruthenium hardly occurs at such a low temperature, resulting in poor yield of the desired compound. According to the present inventors, it is particularly preferable to employ the reaction temperature of about −40° C.

The production reaction for bis(alkyl cyclopentadienyl) ruthenium of the present invention is principally exothermic, and therefore the temperature of the reaction system would increase as the reaction progresses. Accordingly, in the production process for bis(alkyl cyclopentadienyl) ruthenium of the present invention, it is required to cool the reaction system externally to maintain the temperature of the reaction system within the range from −30° C. to −80° C. throughout the reaction.

The process for producing bis(alkyl cyclopentadienyl) ruthenium according the second aspect of the present invention is characterized by comprising reacting alkyl cyclopentadiene represented by Formula (4) with ruthenium chloride of Formula (5) and zinc powder in an alcohol solvent to thereby producing bis(alkyl cyclopentadienyl) ruthenium represented by Formula (6), wherein the alkyl cyclopentadiene is first mixed with zinc powder in the alcohol solvent and subsequently the ruthenium chloride is added to the mixture.

In the process according to the second aspect of the present invention, the order of addition of the starting materials is modified so as to optimize the amount ratio among the starting materials present during the reaction. In the prior art process for producing bis(alkyl cyclopentadienyl) ruthenium, ruthenium chloride is first dissolved in an alcohol solvent and alkyl cyclopentadiene is then mixed to the solution, and finally zinc power is added to the mixture to reduce ruthenium in the ruthenium chloride for the purpose of accelerating the reaction. In the process, the zinc powder is preferably added in portions. This is because, since the production reaction for bis(alkyl cyclopentadienyl) ruthenium is exothermic, if the total amount of zinc powder is added at once, then the reaction system is overheated, resulting in occurrence of an adverse side reaction and polymerization of the reaction product.

In the prior art process, although the desired reaction is accelerated every time a portion of zinc powder is added to the reaction system, the reaction may proceed only to the extent corresponding to the amount of zinc powder added. Therefore, in the early stage of the process, considerable amounts of unreacted ruthenium chloride and alkyl cyclopentadiene come to contact with each other. In other words, the amount ratio among ruthenium chloride, alkyl cyclopentadiene and zinc powder present during the reaction in the prior art process is such a state that ruthenium chloride and alkyl cyclopentadiene are present in excess amounts. When excess amounts of (or unreacted) ruthenium chloride and alkyl cyclopentadiene contact with each other, an adverse side reaction may occur, although to a small extent.

Moreover, in the prior art process, zinc powder is added in portions to a solution of ruthenium chloride in an alcohol solvent for preventing the reaction system from overheating. However, under the condition where the contact between excess amounts of (or unreacted) ruthenium chloride and alkyl cyclopentadiene occurs as in the prior art process, addition of even a small amount of zinc powder may cause the generation of reaction heat, resulting in the increase in temperature of the reaction system. As a result, a side reaction may occur. That is, in the prior art process, it is difficult to control the temperature of the reaction system, and a side reaction is likely to occur.

The present inventors have focused attention to these problems and have modified the order of addition of the starting materials (i.e., ruthenium chloride, alkyl cyclopentadiene and zinc powder) so as to prevent the contact between unreacted ruthenium chloride and alkyl cyclopentadiene during the reaction. According to the present invention, alkyl cyclopentadiene is first mixed with zinc powder and subsequently ruthenium chloride is added to the mixture, whereby the contact between unreacted ruthenium chloride and alkyl cyclopentadiene and the occurrence of a side reaction can be prevented.

The ruthenium chloride may be added in the form of a solid (powder), but preferably is added dropwise in the form of a solution in an alcohol solvent (i.e., a ruthenium chloride-alcohol solution). In this case, it is preferable to prepare a solution of ruthenium chloride dissolved in an alcohol solution (i.e., a ruthenium chloride-alcohol solution) in a step separated from the step of mixing alkyl cyclopentadiene with zinc powder and then add the solution to the reaction system. The ruthenium chloride in the form of a solution controls the concentration of ruthenium chloride in the reaction system more easily and keeps the reaction rate constant. As a result, the reaction for producing bis(alkyl cyclopentadienyl) ruthenium can proceed moderately and a side reaction can be inhibited.

It is also preferable to add the ruthenium chloride in portions. The addition of ruthenium chloride in small portions has such advantages that all of the ruthenium chloride added can be used effectively for the reaction for producing bis(alkyl cyclopentadienyl) ruthenium, that the presence of unreacted ruthenium chloride in the reaction system can be avoided and, consequently, that occurrence of a side reaction can be prevented more effectively.

As mentioned above, the ruthenium chloride is preferably added in the form of a solution. When the ruthenoum chloride is added in the form of a solution in portions, it is preferable that the concentration of ruthenium chloride in a ruthenium chloride-alcohol solution be within the range from 0.01 to 1 mol/L and the ruthenium chloride-alcohol solution be added at a rate of 10 to 50 vol %/h based on the volume of the alcohol. According to the present inventors, by adjusting the amount of the ruthenium chloride added per one time as specified above, overheating of the reaction system can be prevented and the ruthenium chloride added can be fully used for the reaction for producing bis(alkyl cyclopentadienyl) ruthenium.

The reaction temperature to be employed in the process according to the second aspect of the present invention may be higher than −30° C. which falls within the temperature range employed the prior art process. However, in order to prevent the occurrence of a side reaction more effectively, the reaction temperature is preferably kept within the range from −30° C. to −80° C. That is, it is preferable to combine the invention according to the second aspect with the invention according to the first aspect, whereby the occurrence of a side reaction can be prevented almost completely and bis(alkyl cyclopentadienyl) ruthenium having high purity can be produced.

The type of the bis(alkyl cyclopentadienyl) ruthenium which can be produced by the process according to the first or second aspect of the invention is not particularly limited, and various types of bis(alkyl cyclopentadienyl) ruthenium each having any one of various substituents introduced therein can be produced. The type of alkyl cyclopentadiene (i.e., the starting material) may be suitably selected depending on the type of the substituent to be included in the intended bis(alkyl cyclopentadienyl) ruthenium. For example, ethyl cyclopentadiene is used as the starting material for producing bis(ethyl cyclopentadienyl) ruthenium (the substituent R=C₂H₅), and isopropyl cyclopentadiene is used as the starting material for producing bis(isopropyl cyclopentadienyl) ruthenium (the substituent R=C₃H₈).

The ruthenium chloride used may be in the form of a hydrate. The hydrate may be a tri-hydrate or a mixture of a mono-hydrate, a di-hydrate and a tri-hydrate. The zinc powder used should be of high purity, since the object of the present invention is to produce bis(alkyl cyclopentadienyl) ruthenium having high purity. The zinc powder preferably has such a particle size that the zinc powder can be dissolved in the solvent uniformly, preferably a particle size not larger than about 200 mesh. The alcohol to be used as the solvent may be any one, but preferably ethyl alcohol.

As described above, any one of the two processes for producing bis(alkyl cyclopentadienyl) ruthenium according to the present invention can produce bis(alkyl cyclopentadienyl) ruthenium having high purity free from any impurity. As also described above, the type of the bis(alkyl cyclopentadienyl) ruthenium which can be produced according to the present invention is not particularly limited. In recent years, however, bis(ethyl cyclopentadienyl) ruthenium has been focused as a raw material for producing a thin film of ruthenium or ruthenium oxide by the CVD method. The present invention can be especially useful for producing bis(ethyl cyclopentadienyl) ruthenium.

### BRIEF DESCRIPTION OF DRAWINGS

FIG. 1 shows a peak distribution of a gas chromatography of bis(ethyl cyclopentadienyl) ruthenium produced in an embodiment according to the present invention.

FIG. 2 shows the configuration of a CVD apparatus used in an embodiment according to the present invention and a comparative embodiment.

FIG. 3 shows an AFM profile of the surface of a ruthenium thin film produced in an embodiment according to the present invention.

FIG. 4 shows a peak distribution of a gas chromatography of bis(ethyl cyclopentadienyl) ruthenium produced in a comparative embodiment.

FIG. 5 shows an AFM profile of the surface of a ruthenium thin film produced in a comparative embodiment.

### BEST MODE FOR CARRYING OUT THE INVENTION

Hereinbelow, a preferred embodiment according to the present invention will be described together with a comparative embodiment. In the embodiment, bis(ethyl cyclopentadienyl) ruthenium was produced using ethyl cyclopentadiene as the alkyl cyclopentadiene.

### EXAMPLE

Ethyl cyclopentadiene (212 g) and zinc powder (200 mesh, 386 g) were added to ethyl alcohol (an alcohol solvent: 1750 mL) in a flask which had been purged with nitrogen and these components were mixed. In a separate step, ruthenium chloride trihydrate (RuCl₃.3H₂O) (130.7 g) was dissolved in ethyl alcohol (1500 mL) to prepare a ruthenium chloride solution. The ruthenium chloride solution was added dropwise to the mixed solution of ethyl cyclopentadiene and zinc powder over 5 hours at a rate of 300 mL/h while keeping the temperature of the mixed solution at −40° C. After the dropwise addition of the ruthenium chloride solution was completed, the reaction solution was allowed to react for 24 hours while maintaining the reaction solution under cooled condition so that the temperature of the reaction solution was kept at −40° C.

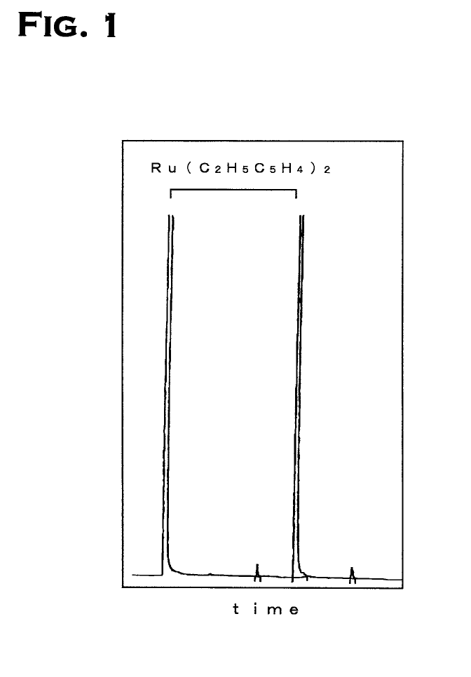

After the reaction was completed, the reaction solution was extracted with hexane. Hexane was distilled off from the extraction solvent which contained bis(ethyl cyclopentadienyl) ruthenium, thereby yielding bis(ethyl cyclopentadienyl) ruthenium (102 g). The bis(ethyl cyclopentadienyl) ruthenium was analyzed by gas chromatography and confirmed to have a extremely high purity of 99.5%. The profile of the gas chromatography of the bis(ethyl cyclopentadienyl) ruthenium is shown in FIG. 1. As shown in FIG. 1, most of the peaks observed in the profile were of bis(ethyl cyclopentadienyl) ruthenium and little peaks corresponding to impurities were observed.

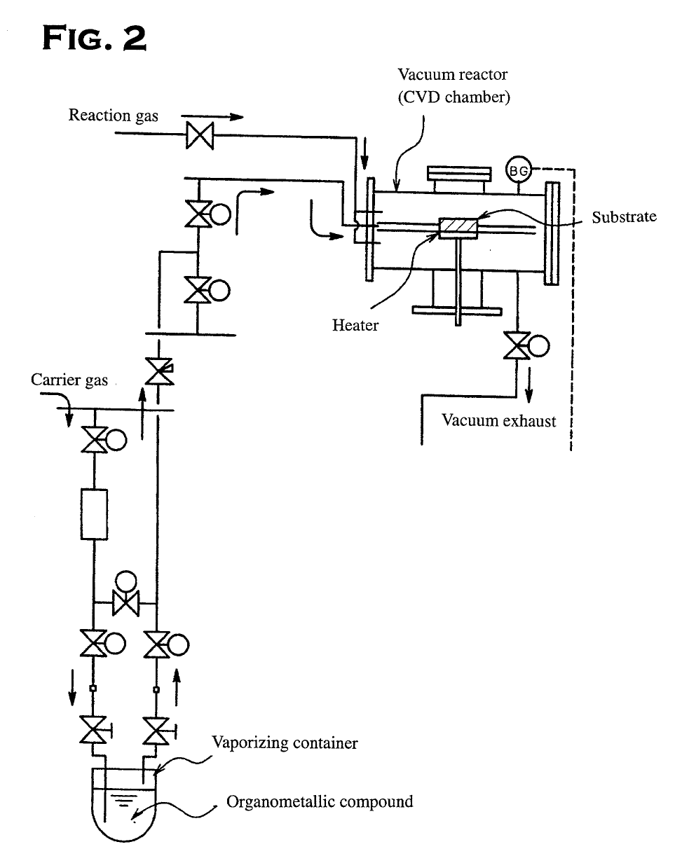

Next, the bis(ethyl cyclopentadienyl) ruthenium produced in the embodiment was used to produce a ruthenium thin film using a CVD apparatus illustrated in FIG. 2. The reaction conditions were as follows.

| | |
|---|---|
| Temperature of substrate: | 300° C. |
| Chamber pressure: | 700 Pa (5 torrs) |
| Carrier gas: | argon/oxygen |
| Flow rate of carrier gas: | 200/200 sccm |

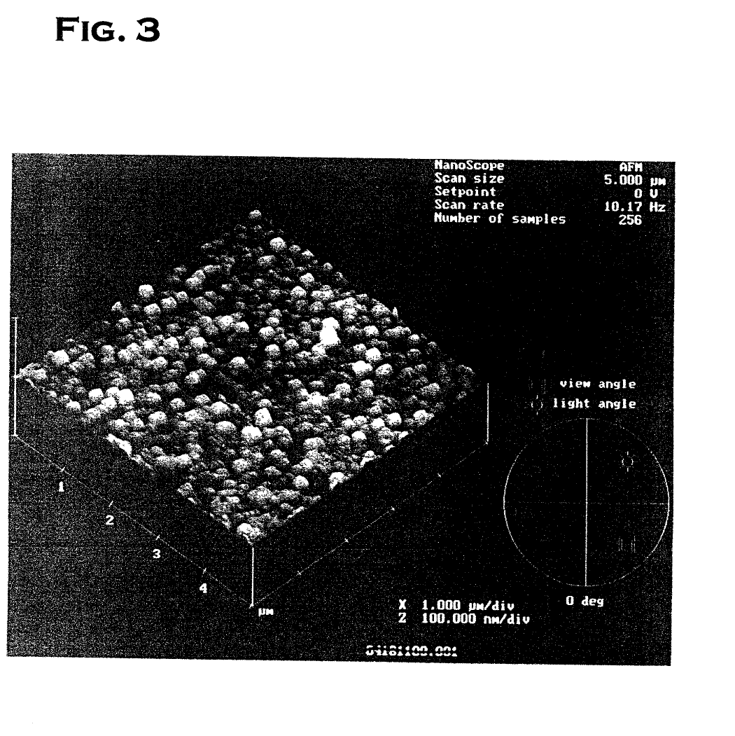

The surface of the ruthenium thin film produced under these conditions was analyzed by AFM (Atomic Force Microscope) to determine the morphology and the roughness of the surface of the thin film. FIG. 3 shows the AFM profile of the surface of the ruthenium thin film produced by the embodiment. It was confirmed that the thin film had a mean surface roughness (Rₘₛ) of 4 nm, which is excellent, and good morphology.

### COMPARATIVE EXAMPLE

To assess the purity of the bis(ethyl cyclopentadienyl) ruthenium produced in Example, bis(ethyl cyclopentadienyl) ruthenium was also produced by a conventional process and the purity thereof was determined. The resulting bis(ethyl cyclopentadienyl) ruthenium was used to produce a ruthenium thin film by the CVD method and the properties thereof was examined.

Ethyl alcohol (an alcohol solvent: 3250 mL) and ruthenium chloride trihydrate (130.7 g) were dispensed in a flask which had been purged with nitrogen and the components were dissolved to each other. Ethyl cyclopentadiene (212 g) which had been cooled to −20° C. was added to the solution. Zinc powder (95.5 g) was added to the mixed solution in seven portions at intervals of 10 min. while keeping the solution within the temperature range from −10° C. to −30° C. and stirring the solution, and then allowed to react. Thereafter, the reaction solution was maintained at 10° C. for 20 min.

The reaction solution was extracted with hexane. Hexane was distilled off from the extraction solvent which contained bis(ethyl cyclopentadienyl) ruthenium, thereby yielding bis(ethyl cyclopentadienyl) ruthenium (190 g).

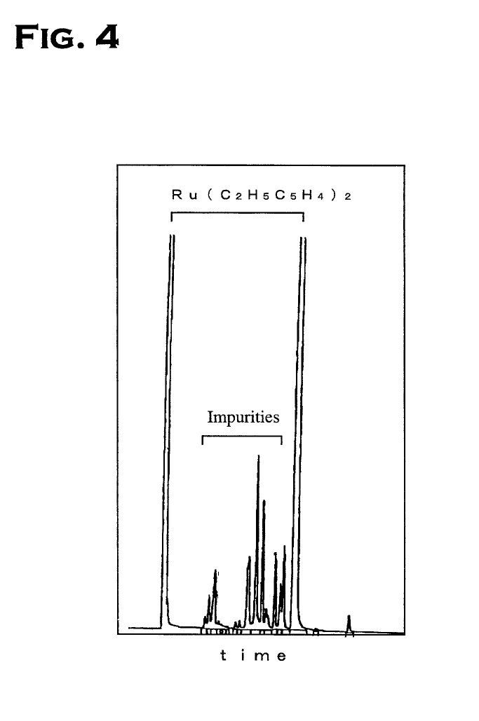

The bis(ethyl cyclopentadienyl) ruthenium was analyzed by gas chromatography and confirmed to have an extremely low purity of 94.5%. The profile of the gas chromatography of the bis(ethyl cyclopentadienyl) ruthenium is shown in FIG. 4. As shown in FIG. 4, although most of the peaks observed in the profile were of bis(ethyl cyclopentadienyl) ruthenium, many peaks corresponding to impurities were also observed.

Next, the bis(ethyl cyclopentadienyl) ruthenium produced in Comparative Example was used to produce a ruthenium thin film using a CVD apparatus illustrated in FIG. 2. The reaction conditions employed were the same as those in Example.

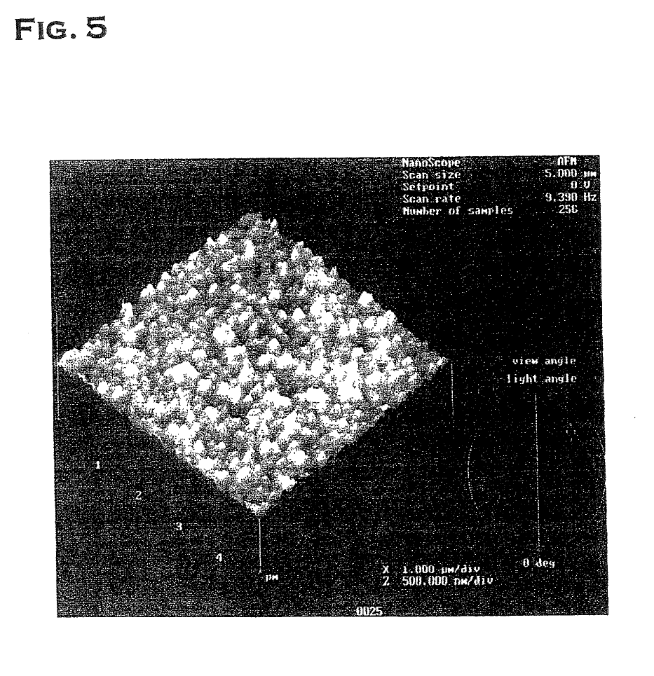

The surface of the ruthenium thin film was analyzed by AFM to determine the morphology and the roughness of the surface of the thin film. The AFM profile of the surface of the ruthenium thin film produced by Comparative Example is shown in FIG. 5. It was confirmed that the thin film had a mean surface roughness (Rₘₛ) of 26 nm and therefore had a very rough surface. The difference in surface condition between the thin film produced in Example and the thin film produced in Comparative Example is considered to be caused by impurities which are contained in the starting material bis(ethyl cyclopentadienyl) ruthenium produced in Comparative Example.

1. A process for producing bis(alkyl cyclopentadienyl) ruthenium comprising reacting alkyl cyclopentadiene represented by Formula (1) with ruthenium chloride of Formula (2) and zinc powder in an alcohol solvent to thereby produce bis(alkyl cyclopentadienyl) ruthenium represented by Formula (3),
the reaction being effected at a temperature within the range from −30° C. to −80° C.:
Formula (1): 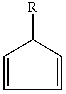
wherein a substituent R represents a strait-chain or branched alkyl group;
Formula (2):
RuCl₃; and
Formula (3): 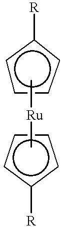
wherein a substituent R is as defined above.

2. A process for producing bis(alkyl cyclopentadienyl) ruthenium comprising reacting alkyl cyclopentadiene represented by Formula (1) with ruthenium chloride of Formula (2) and zinc powder in an alcohol solvent to thereby producing bis(alkyl cyclopentadienyl) ruthenium represented by Formula (3),
the alkyl cyclopentadiene being mixed with zinc powder in the alcohol solvent and subsequently the ruthenium chloride being added thereto.

3. The process producing bis(alkyl cyclopentadienyl) ruthenium according to claim 2, wherein the ruthenium chloride is added dropwise in the form of a solution of ruthenium chloride in an alcohol (a ruthenium chloride-alcohol solution).

4. The process for producing bis(alkyl cyclopentadienyl) ruthenium according to claim 2 or 3, wherein the ruthenium chloride is added in portions.

5. The process for producing bis(alkyl cyclopentadienyl) ruthenium according to claim 4, wherein the ruthenium chloride is added in portions in such a manner that a solution of ruthenium chloride in an alcohol (a ruthenium chloride-alcohol solution) which contains the ruthenium chloride at a concentration of 0.01 to 1 mol/L is added dropwise at a rate of 10 to 50 vol %/h based on the volume of the alcohol.

6. The process for producing bis(alkyl cyclopentadienyl) ruthenium according to any one of claims 2 to 5, wherein the reaction is effected at a temperature within the range from −30° C. to −80° C.

7. Bis(alkyl cyclopentadienyl) ruthenium produced by the process according to any one of claims 1 to 6.

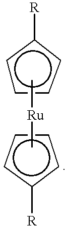

8. The bis(alkyl cyclopentadienyl) ruthenium according to claim 7, wherein the substituent R is an ethyl group (C₂H₅).
